(19) United States
(12) Patent Application Publication
(10) Pub. No.: US 2016/0366916 A1
(43) Pub. Date: Dec. 22, 2016

(54) FORMULA FOR MANAGEMENT OF PHENYLKETONURIA

(71) Applicant: Cambrooke Therapeutics, Inc., Ayer, MA (US)

(72) Inventors: SUSAN GINGRICH, Hamilton, MA (US); Kurt Olson, Chicago, IL (US)

(73) Assignee: Cambrooke Therapeutics, Inc., Ayer, MA (US)

(21) Appl. No.: 15/184,416

(22) Filed: Jun. 16, 2016

Related U.S. Application Data
(60) Provisional application No. 62/181,754, filed on Jun. 18, 2015.

(51) Int. Cl. A23L 1/30; A23L 2/66; A23L 2/52

(52) U.S. Cl. CPC A23L 1/296; A23L 2/66; A23L 2/52; A23V 2002/00

(57) ABSTRACT

Described herein is a nutrition formula, which is a powder that comprises components described herein and can be combined with a liquid, such as water, to produce a milk-like beverage for the dietary management of phenylketonuria (PKU). The powder and resulting beverage have a balanced amino acid profile suitable for dietary management of individuals who have PKU and are lower in calories than powder and milk-like beverages that comprise whey protein, such as cGMP, presently available for use in dietary management of PKU.

### RELATED APPLICATION

This application claims the benefit of the filing date of U.S. Provisional Application No. 62/181,754, filed Jun. 18, 2015. The teachings of the referenced application are incorporated by reference herein in their entirety.

### BACKGROUND

Phenylketonuria (PKU) is an inherited metabolic error that results in a toxic build-up of phenylalanine (Phe) in the brain and plasma. Infants are screened at birth to determine if they have the genetic defect responsible for PKU. If an infant is diagnosed with the condition, treatment must be initiated immediately, if there is to be a positive outcome. If PKU is undetected or untreated, the nervous system will suffer severe, irreversible damage and the individual will become severely mentally handicapped. Infants diagnosed with PKU must consume a low phenylalanine diet for life to avoid being affected. The original treatment for this disorder was simply to restrict protein in the diet. This fell far short of what was needed. Berry (1980) found that supplementing the diet with valine, isoleucine, and leucine provided a method for improving outcome.

Subsequently, the PKU diets were composed of foods low in protein (and Phe) supplemented with a formula to provide complete nutrition, including amino acids, carbohydrate, fat and essential vitamin and minerals.

Compliance is a concern for those with PKU and additional approaches to making palatable and nutritious foods suitable for those with PKU are needed.

### SUMMARY

Described herein is a nutrition formula, which is a powder that comprises components described herein and can be combined with a liquid, such as water, to produce a milk-like beverage for the dietary management of phenylketonuria (PKU). The powder and resulting beverage have a balanced amino acid profile suitable for dietary management of individuals who have PKU and are lower in calories than other powder and milk-like beverages. In some embodiments, the nutrition formula powder comprises from 75-100 calories per 10 gm protein equivalent (PE). In specific embodiments, the nutrition formula powder comprises no more than about 79 or about 80 calories per 10 gm protein equivalents. In additional embodiments, the nutrition formula powder comprises no more than 100 calories per 10 gm PE. The nutrition formula powder is low in phenylalanine and produces a beverage that has low osmoiality and an acceptable taste.

In one embodiment, the nutrition formula comprises: (a) a protein source that comprises (i) whey protein, such as whey protein isolate, such as caseino-glyco-macropeptide (cGMP) and (ii) complementary essential amino acids which are a mixture of tyrosine, arginine, tryptophan, leucine and histidine and, in combination, provide a balanced amino acid profile and (b) a carbohydrate source, which typically includes non-reducing sugars to minimize/reduce browning potential. This embodiment can further comprise vitamins and minerals, such as vitamins and minerals in sufficient quantities to meet the daily requirement for each. In a further embodiment, the nutrition formula comprises: (a) a protein source that comprises (i) whey protein, such as whey protein isolate, such as caseino-glyco-macropeptide (cGMP) and (ii) complementary essential amino acids which are a mixture of tyrosine, arginine, tryptophan, leucine and histidine and, in combination, provide a balanced amino acid profile; (b) a carbohydrate source, which typically includes non-reducing sugars to minimize/reduce browning potential; (c) a fat (lipid/oil) source; and typically, but optionally, (d) vitamins and minerals, such as vitamins and minerals in sufficient quantities to meet the daily requirements for each. In addition, the nutrition formula typically, but optionally, includes flavors, which can be natural or artificial or a combination of both; coloring agents, which can be natural or artificial or a combination of both; sweetener, which can be natural or artificial or a combination of both; gelling agents, thickening agents, stabilizing agents, sequestrants, emulsifiers or a combination of two or more of gelling agents, thickening agents, stabilizing agents, sequestrants, emulsifiers, each of which can be natural or artificial or a combination of both.

In some embodiments, the protein source provides 40-70% of the energy (calories) of the nutrition formula. In specific embodiments, the % of calories provided by the protein source is from 50-55%, such as 50%, 51%, 52%, 53%, 54%, or 55%. In further specific embodiments, the % of calories provided by the protein source is from 60-70%, such as 60%, 61%, 62%, 63%, 64%, 65%, 66%, 67%, 68%, 69%, or 70%. In further specific embodiments, the % of calories provided by the protein source is from 40-49%, such as 40%, 41%, 42%, 43%, 44%, 45%, 46%, 47%, 48%, or 49%.

In specific embodiments, the formula comprises (a) a protein source that comprises whey protein, such as whey protein isolate, such as caseino-glyco-macropeptide (cGMP) and (ii) complementary essential amino acids which are a mixture of tyrosine, arginine, tryptophan, leucine and histidine and, in combination, provide a balanced amino acid profile; (b) a carbohydrate source, which typically includes non-reducing sugars to minimizelreduce browning potential; and (c) a fat (lipid/oil) source, such as in the quantities shown in the tables (Table 1 and Table 2). The formula can further comprise vitamins, minerals or vitamins and minerals. In specific embodiments, the nutritional formula comprises modified starch.

In further specific embodiments, the formula comprises (a) protein source that comprises (i) caseino-glyco-macropeptide (cGMP) and (ii) complementary essential amino acids which are a mixture of tyrosine, arginine, tryptophan, leucine and histidine and, in combination, provide a balanced amino acid profile; (b) a carbohydrate source, which typically includes non-reducing sugars to minimize/reduce browning potential; (c) a fat (lipid/oil) source; and, optionally, (d) vitamins, minerals or vitamins and minerals in amounts and forms to provide, per serving (approximately 1.9 oz or 100 g packet) or per 100 gm, the amounts listed in the tables (Table 1 and Table 2).

The amount of each component in the formula can be varied, as desired, and typically the amount will be within the range shown in Table 1 for each component. In specific embodiments, the nutrition formula includes no more than 75-100 calories per 10 gm protein equivalent. For example, some embodiments of the nutrition formula include no more than 75 calories per 10 gm protein equivalent; no more than 76 calories per 10 gm protein equivalent; no more than 77 calories per 10 gm protein equivalent; no more than 78 calories per 10 gm protein equivalent; no more than79 calories per 10 21:n protein equivalent; no more than 80 calories per 10 gm protein equivalent; no more than 81 calories per 10 gm protein equivalent; no more than 82 alories per 10 gin protein equivalent; no more than 83 calories per 10 gm protein equivalent; no more than 84 calories per 10 gm protein equivalent; no more than 85 calories per 10 gm protein equivalent; no more than 86 calories per 10 gm protein equivalent; no more than 87 calories per 10 gm protein equivalent; no more than 88 calories per 10 gm protein equivalent; no more than 89 calories per 10 gm protein equivalent; no more than 90 calories per 10 gm protein equivalent; no more than 91 calories per 10 gm protein equivalent; no more than 92 calories per 10 gm protein equivalent; no more than 93 calories per 10 gm protein equivalent; no more than 94 calories per 10 gm protein equivalent; no more than 95 calories per 10 gm protein equivalent; no more than 96 calories per 10 gm protein equivalent; no more than 97 calories per 10 gm protein equivalent; no more than 98 calories per 10 gm protein equivalent; no more than 99 calories per 10 gm protein equivalent; or no more than 100 calories per 10 gm protein equivalent. In specific embodiments, the nutrition formula is a powder that includes from about 75 to about 80 calories per 10 gm protein equivalent, such as about 75, about 76, about 77, about 78, about 79 or about 80 calories per 10 gm protein equivalent. In further embodiments, the nutrition formula is a powder that includes from about 80 to about 85 calories per 10 gm protein equivalent, such as about 80, about 81, about 82, about 83, about 84 or about 85 calories per 10 gm protein equivalent. In further embodiments, the nutrition formula is a powder that includes from about 85 to about 90 calories per 10 gin protein equivalent, such as about 85, about 86, about 87, about 88, about 89 or about 90 calories per 10 gm protein equivalent. In further embodiments, the nutrition formula is a powder that includes from about 90 to about 100 calories per 10 gm protein equivalent, such as about 90, about 91, about 92, about 93, about 94, about 95 about 96, about 97, about 98, about 99 or about 100 calories per 10 gm protein equivalent.

The amount of each complementary essential amino acid in the formula can also be varied, as needed. In some embodiments, the nutrition formula includes amounts of complementary essential amino acids in the amounts shown in the tables (Table 1 and Table 7),

The amount of carbohydrate source in the nurition formula described herein can also be varied, as needed. In some embodiments, the nutrition formula includes from about 10 to 16 gm carbohydrate source per serving formula, such as 10, 11, 12, 13, 14, 15 or 16 gm carbohydrate source per serving nutrition formula powder,

The amount of fat (lipid/oil) source in the formula described herein can also be varied, as needed. In some embodiments, the formula includes from about 1.0 gm to about 3.0 gm fat (lipid/oil source per serving formula, such as 1.0, 1.5, 2.0, 2.5, or 3.0 gm fat (lipid/oil) source per serving nutrition formula powder. In a further embodiment, the formula includes from about 1.6 gm to about 2.4 gm fat (lipid/oil) source per serving formula, such as 1.6, 1.7, 1.8, 1.9, 2.0, 2.1, 2.2, 2.3, or 2,4 gm fat (lipid/oil) source per serving nutrition formula powder.

The amount of each vitamin and each mineral source in the formula described herein can be varied, as needed. The vitamins and minerals can be included in the nutrition formula in amounts shown in the tables (Table 1 and Table 2).

The amount of each complementary essential amino acid present in the formula described herein can be varied relative to the amount of protein equivalent (PE) present in the formula. In some embodiments, the amount of each complementary essential amino acid is included in the nutrition formula in any combination of the amounts shown in the tables (Table 1 and Table 2), such as the amount of each shown per serving in the tables (Table 1 and Table 2).

TABLE 1

| Component | per serving* | Range | Per 100 g |
|---|---|---|---|
| Calories: | 150 | 120-180 | 283 |
| Cal From Fat: | 17.6 | 14.1-21.1 | 33 |
| Protein Equiv, g: | 20 | 16-24 | 38 |
| Free Amino Acids, g: | | | |
| Phenylalanine, mg: | 35 | 28-42 | 66 |
| Carbohydrates, g: | 13 | 10.4-15.6 | 25 |
| Sugar, g: | 4 | 3.2-4.8 | 8 |
| Sugar Alcohols, g: | 0 | | 0 |
| Dietary Fiber, g: | 1.8 | 1.4-2.2 | 3 |
| Fat, g: | 2.0 | 1.6-2.4 | 3.8 |
| Saturated Fat, g: | 0.2 | 0.16-0.24 | 0.4 |
| Trans Fat, g: | 0.0 | | 0.0 |
| Cholesterol, mg: | .5 | 0.4-06 | 1 |
| Vitamin A, IU: | 1080.0 | 864-1296 | 2037.7 |
| Vitamin C, mg; | 40.0 | 32-48 | 75.5 |
| Vitamin D, IU: | 668.0 | 534.4-801.6 | 1260.4 |
| Vitamin E, IU: | 10.7 | 8.6-12.8 | 20.2 |
| Vitamin K1, mcg: | 20.0 | 16-24 | 37.7 |
| Vitamin K2 (MK-7), mcg: | 20.0 | 16-24 | 37.7 |
| Thiamin (B1), mg: | 0.5 | 0.4-0.6 | 0.9 |
| Riboflavin (B2), mg: | 0.5 | 0.4-0.6 | 0.9 |
| Niacin (B3), mg: | 6.6 | 5.3-7.9 | 12.5 |
| Vitamin B6, mg: | 0.5 | 0.4-06 | 1.0 |
| Folic acid, mcg: | 188.6 | 150.9-226.3 | 355.8 |
| Vitamin B12, mcg: | 1.0 | 0.8-1.2 | 1.9 |
| Pantothenic acid (B5), mg: | 2.4 | 1.9-2.9 | 4.5 |
| Biotin, mcg: | 10.0 | 8-12 | 18.9 |
| Choline, mg: | 159.0 | 127.2-190.8 | 300.0 |
| Calcium, mg: | 716.5 | 573.2-859.8 | 1351.9 |
| Chromium, mcg: | 17.3 | 13.8-20.8 | 32.6 |
| Copper, mg: | 0.2 | 0.16-0.24 | 0.4 |
| Iodine, mcg: | 77.1 | 61.7-92.5 | 145.5 |
| Iron, mg: | 8.0 | 6.4-9.6 | 15.1 |
| Magnesium, mg: | 175.5 | 140.4-210.6 | 331.1 |
| Manganese, mg: | 1.0 | 0.8-1.2 | 1.9 |
| Molybdenum, mcg: | 20.5 | 16.4-24.6 | 38.7 |
| Phosphorus, mg: | 678.5 | 542.8-814.2 | 1280.2 |
| Selenium, mcg: | 26.6 | 21.3-31.9 | 50.2 |
| Zinc, mg: | 5.0 | 4-6 | 9.4 |
| Potassium, mg: | 801.0 | 640.8-961.2 | 1511.3 |
| Sodium, mg: | 375.8 | 299.6-452 | 709.1 |
| Chloride, mg: | 20.0 | 16-24 | 37.7 |
| Inositol, mg: | 0.0 | | 0.0 |
| L-alanine, mg: | 1033.0 | 826.4-1239.6 | 1949.1 |
| L-arginine, mg: | 1765.0 | 1412-2118 | 3330.2 |
| L-aspartate, mg: | 1472.0 | 1177.6-1766.4 | 2777.4 |
| L-cysteine, mg: | 16.3 | 13-19.6 | 30.8 |
| L-glutamate, mg: | 3225.0 | 2580-3870 | 6084.9 |
| L-glycine, mg: | 188.0 | 150.4-225.6 | 354.7 |
| L-histidine, mg: | 469.4 | 375.5-563.3 | 885.7 |
| L-isoleucine, mg: | 1770.0 | 1416-2124 | 3339.6 |
| L-leucine, mg: | 3920.0 | 3136-4704 | 7396.2 |
| L-lysine, mg: | 1033.5 | 826.8-1240.2 | 1950.0 |
| L-methionine, mg: | 410.0 | 328-492 | 773.6 |
| L-phenylalanine, mg: | 35.0 | 28-42 | 66.0 |
| L-proline, mg: | 2000.0 | 1600-2400 | 3773.6 |
| L-serine, mg: | 1268.0 | 1014.4-1521.6 | 2392.5 |
| L-threonine, mg: | 2865.0 | 2292-3438 | 5405.7 |
| L-tryptophan, mg: | 257.0 | 205.6-308.4 | 484.9 |
| L-tyrosine, mg: | 1840.0 | 1472-2208 | 3471.7 |
| L-valine, mg: | 1420.0 | 1136-1704 | 2679.2 |

*serving size: 1.9 oz (53 gm) packet

TABLE 2
Serving Size: 1.9 oz (53 g) pkt
Servings/Cont: 30
NetWt: 3.5 LBS (1.6 KG)
Quantity/PKG: 30
Product Type: Drink Powder
Category: Glytactin FKU

| | per serving | per 100 g | | per serving | per 100 g | | | |
|---|---|---|---|---|---|---|---|---|
| Calories: | 150 | 288 | Sugar Alcohols, g: | 0 | 0 | Osmolality, mOsm/kg: | | |
| Cal From Fat: | 17.6 | 34 | Dietary Fiber, g: | 1.8 | 3 | | pH: | 6.6 |
| Protein Equiv, g: | 20 | 38 | Fat, g: | 2.0 | 3.8 | | | |
| Free Amino Acids, g: | | | Saturated Fat, g: | 0.2 | 0.4 | | | |
| Phenylalanine, mg: | 35 | 67 | Trans Fat, g: | 0.0 | 0.0 | | | |
| Carbohydrates, g: | 13 | 25 | Cholesterol, mg: | .5 | 1 | | | |
| Sugar, g: | 4 | 8 | | | | | | |
| Vitamin A, IU: | 1200.0 | 2307.7 | Folic acid, mcg: | 188.6 | 362.7 | Manganese, mg: | 1.0 | 1.9 |
| Vitamin C, mg: | 45.0 | 86.5 | Vitamin B12, mcg: | 1.0 | 1.9 | Molybdenum, mcg: | 20.5 | 39.4 |
| Vitamin D, IU: | 668.0 | 1284.6 | Panto. acid (B5), mg: | 2.4 | 4.6 | Phosphorus, mg: | 678.5 | 1304.8 |
| Vitamin E, IU: | 10.7 | 20.6 | Biotin, mcg: | 10.0 | 19.2 | Selenium, mcg: | 26.6 | 51.2 |
| Vitamin K1, mcg: | 20.0 | 38.5 | Choline, mg: | 159.0 | 305.8 | Zinc, mg: | 5.0 | 9.6 |
| Vitamin K2 (MK-7), mcg: | 20.0 | 38.5 | Calcium, mg: | 716.5 | 1377.9 | Potassium, mg: | 801.0 | 1540.4 |
| Thiamin (B1), mg: | 0.5 | 1.0 | Chromium, mcg: | 17.3 | 33.3 | Sodium, mg: | 375.8 | 722.7 |
| Riboflavin (B2), mg: | 0.5 | 1.0 | Copper, mg: | 0.2 | 0.4 | Chloride, mg: | 20.0 | 38.5 |
| Niacin (B3), mg: | 6.6 | 12.7 | Iodine, mcg: | 77.1 | 148.3 | Inositol, mg: | 0.0 | 0.0 |
| Vitamin B6, mg: | 0.5 | 1.0 | Iron, mg: | 8.0 | 15.4 | | | |
| Folate (L- | | | Magnesium, mg: | 175.5 | 337.5 | | | |
| methylfolate), mg: | | | | | | | | |
| L-alanine. mg: | 1033.0 | 1986.5 | L-lysine, mg: | 1033.5 | 1987.5 | | | |
| L-arginine, mg: | 1765.0 | 3394.2 | L-methionine, mg: | 410.1 | 766.7 | | | |
| L-aspartate, mg: | 1472.0 | 2830.8 | L-phenylalanine, mg: | 40.0 | 76.9 | | | |
| L-cysteine, mg: | 16.3 | 31.3 | L-proline, mg: | 2000.0 | 3846.2 | | | |
| L-glutamate, mg: | 3225.0 | 6201.9 | L-serine, mg: | 1268.0 | 2438.5 | | | |
| L-glycine, mg: | 188.0 | 361.5 | L-threonine, mg: | 2865.0 | 5509.6 | | | |
| L-histidine, mg: | 469.4 | 902.7 | L-tryptophan, mg: | 265.0 | 509.6 | | | |
| L-isoleucine, mg: | 1770.0 | 3403.8 | L-tyrosine, mg: | 1840.0 | 3538.5 | | | |
| L-leucine, mg: | 3920.0 | 7538.5 | L-valine, mg: | 1420.0 | 2730.8 | | | |

Ingredients: Whey protein isolate, vitamin and mineral blend (calcium lactate, monosodium phosphate, monopotassium phosphate, magnesium amino acid chelate, choline bitartrate, sodium ascorbate, dl-alpha-tocopheryl acetate, Fe amino acid chelate, niacinamide, zinc amino acid chelate, calcium d-pantothenate, manganese sulfate, thiamin HCl, vitamin B6 pyridoxine HCl, riboflavin, copper gluconate, folic acid, vitamin A palmitate, potassium iodide, sodium selenite, vitamin K1 phytonadione, vitamin K2 MK-7, sodium molybdate, chromium chloride, D3 cholecalciferol, biotin, vitamin B12 cyanocobalamin), trehalose, leucine, non-dairy creamer (sunflower oil, corn syrup solids, food starch-modified, mono and diglycerides, natural flavor, citric acid, carrageenan), natural flavors (maltodextrin, acacia gum, propylene glycol, tricalcium phosphate, dextrose, silicon dioxide), maltodextrin, inulin, tyrosine, arginine, DHA algal oil (glucose syrup solids, algal oil, mannitol, sodium caseinate [milk], soy protein, high oleic sunflower oil, sodium ascorbate, 2% or less: tricalcium phoshate, tetrasodium diphosphate, soy lecithin, mixed natural tocopherols and ascorbyl palmitate [as antioxidants], probiotic (skim milk powder, Bacillus coagulans GBI-30 6086), histidine, tryptophan, acesulfame potassium, methionine, sucralose. Contains milk and soy. Also contains corn.
Preparation: Fill a shaker cup to the 4 oz mark with cold water (add more or less water to suit your taste). Open packet at tear guide and pour into cup. Shake or stir until completely dissolved. (Will make about 6 oz total liquid.)

We claim:

1. A nutrition formula for management of phenylketonuria, comprising: (a) a protein source that comprises (i) whey protein, such as whey protein isolate, such as caseino-glyco-macropeptide (cGMP) and (ii) complementary essential amino acids which are a mixture of tyrosine, arginine, tryptophan, leucine and histidine and, in combination, provide a balanced ammo acid profile; (b) a carbohydrate source; (c) a fat (lipid/oil) source; and, optionally, (d) vitamins and minerals, wherein the nutrition formula comprises from 75-100 calories per 10 gm protein equivalents (PE).

2. The nutrition formula of claim 1 that includes about 20 gm protein equivalents per serving.

3. The nutrition formula of claim 1 or claim 2 which is a powder and a serving is about 1.9 oz.

4. The nutrition formula of claim 3, wherein a serving provides about 150 calories, including about 52 calories from carbohydrates, about 80 calories from protein equivalents and about 18 calories from fat.

5. The nutrition formula according to claim 1 in which the protein source provides 40-70% of the energy of the nutritional formula.

6. The nutrition formula according to claim 1, comprising the following complementary amino acids per gram of protein equivalent (PE).

| | |
|---|---|
| Tyrosine (mg/gm PE) | 92 |
| Arginine (mg/gm PE) | 88 |
| Tryptophan (mg/gm PE) | 13 |
| Leucine (mg/gm PE) | 196 |
| Histidine (mg/gm PE) | 24 |

all percentages being by weight of the complementary amino acids, amino acid esters, or salts of amino acids.

7. A nutrition formula powder comprising:

| | |
|---|---|
| Calories | 150 |
| Cal From Fat | 17.6 |
| Protein Equivalent, g | 20 |
| Phenylalanine, mg | 35 |
| Carbohydrates, g | 13 |
| Sugar, g | 4 |
| Sugar Alcohols, g | 0 |
| Dietary Fiber, g | 1.8 |
| Fat, g | 2.0 |
| Saturated Fat, g | 0.2 |
| Trans Fat, g | 0.0 |
| Cholesterol, mg | .5 |
| Vitamin A, IU | 1080.0 |
| Vitamin C, mg; | 40.0 |
| Vitamin D, IU | 668.0 |
| Vitamin E, IU | 10.7 |
| Vitamin K1, mcg | 20.0 |
| Vitamin K2 (MK-7), mcg | 20.0 |
| Thiamin (B1), mg | 0.5 |
| Riboflavin (B2), mg | 0.5 |
| Niacin (B3), mg | 6.6 |
| Vitamin B6, mg | 0.5 |
| Folic acid, mcg | 188.6 |
| Vitamin B12, mcg | 1.0 |
| Pantothenic acid (B5), mg | 2.4 |
| Biotin, mcg | 10.0 |
| Choline, mg | 159.0 |
| Calcium, mg | 716.5 |
| Chromium, mcg | 17.3 |
| Copper, mg | 0.2 |
| Iodine, mcg | 77.1 |
| Iron, mg | 8.0 |
| Magnesium, mg | 175.5 |
| Manganese, mg | 1.0 |
| Molybdenum, mcg | 20.5 |
| Phosphorus, mg | 678.5 |
| Selenium, mcg | 26.6 |
| Zinc, mg | 5.0 |
| Potassium, mg | 801.0 |
| Sodium, mg | 375.8 |
| Chloride, mg | 20.0 |
| Inositol, mg | 0.0 |
| L-alanine, mg | 1033.0 |
| L-arginine, mg | 1765.0 |
| L-aspartate, mg | 1472.0 |
| L-cysteine, mg | 16.3 |
| L-glutamate, mg | 3225.0 |
| L-glycine, mg | 188.0 |
| L-histidine, mg | 469.4 |
| L-isoleucine, mg | 1770.0 |
| L-leucine, mg | 3920.0 |
| L-lysine, mg | 1033.5 |
| L-methionine, mg | 410.0 |
| L-phenylalanine, mg | 35.0 |
| L-proline, mg | 2000.0 |
| L-serine, mg | 1268.0 |
| L-threonine, mg | 2865.0 |
| L-tryptophan, mg | 257.0 |
| L-tyrosine, mg | 1840.0 |
| L-valine, mg | 1420.0 |

per 1.9 oz. (53 gm) packet of formula, wherein the protein equivalent comprises whey protein.

8. The powder nutritional formula of claim 7, wherein the protein equivalent comprises whey protein isolate.

9. The powder nutritional formula of claim 7, wherein the protein equivalent comprises caseino-glyco-macropeptide (cGMP).

10. A nutrition formula for management of phenylketonuria, comprising: (a) a protein source that comprises (i) whey protein, such as whey protein isolate, such as caseino-glyco-macropeptide (cGMP) and (ii) complementary essential amino acids which are a mixture of tyrosine, arginine, tryptophan, leucine and histidine and, in combination, provide a balanced ammo acid profile; (b) a carbohydrate source; (c) a fat (lipid/oil) source; and, optionally, (d) vitamins and minerals, wherein the nutrition formula comprises no more than about 80 calories per 10 gm protein equivalents (PE) and each of (a), (b) and (c) are present in a serving of drink powder in the amounts listed in Table 1 or Table 2 and if (d) is present, the vitamins and minerals are present in a serving of drink powder in the amounts listed in Table 1 or Table 2.

11. The nutritional formula of claim 1, wherein the protein source comprises 20 g protein equivalents per 1.9 oz serving and no more than about 80 calories per 10 gm protein equivalents.

12. The nutritional formula of claim 11, wherein (a), (b) and (c) are present in the amount shown in the Table 1 or Table 2.
